(19) United States
(12) Patent Application Publication
(10) Pub. No.: US 2026/0121266 A1
(43) Pub. Date: Apr. 30, 2026

(54) Battery Cell, and Battery Pack and Vehicle Including the Same

(71) Applicant: LG Energy Solution, Ltd., Seoul (KR)

(72) Inventors: Seung-Hun Lee, Daejeon (KR); Sung-Min Cho, Daejeon (KR); Do-Gyun Kim, Daejeon (KR); Jun-Ho Baek, Daejeon (KR); Tae-Rim Hong, Daejeon (KR)

(73) Assignee: LG Energy Solution, Ltd., Seoul (KR)

(21) Appl. No.: 19/367,078

(22) Filed: Oct. 23, 2025

(30) Foreign Application Priority Data
Oct. 25, 2024 (KR) 10-2024-0147484

(51) Int. Cl. H01M 50/645; H01M 10/04; H01M 50/107; H01M 50/152; H01M 50/169; H01M 50/249; H01M 50/533; H01M 50/538; H01M 50/566

(52) U.S. Cl. CPC H01M 50/645; H01M 10/0422; H01M 10/0431; H01M 50/107; H01M 50/152; H01M 50/169; H01M 50/249; H01M 50/533; H01M 50/538; H01M 50/566

(57) ABSTRACT

A battery cell may include an electrode assembly in which a first electrode and a second electrode as well as a separator interposed therebetween are wound about a winding axis so that a winding center hole extending in a winding axis direction is formed at a center. A battery housing is configured to accommodate the electrode assembly through an open end formed at one side of the battery housing. A lead is configured to cover the open end and has an injection hole formed at a center thereof. A plug is configured to be inserted into the injection hole and seal the injection hole. The size of the injection hole may be smaller than the size of the winding center hole.

### CROSS-REFERENCE TO RELATED APPLICATIONS

This application claims priority from Korean Patent Application No. 10-2024-0147484, filed on Oct. 25, 2024, the entire disclosure of which is hereby incorporated herein by reference.

### TECHNICAL FIELD

The present disclosure relates to a battery cell, and a battery pack and a vehicle including the same.

### BACKGROUND ART

A cylindrical battery cell has a structure that accommodates a jelly-roll type electrode assembly inside a cylindrical metal can, and is more resistant to shock and temperature than a pouch-type battery. Accordingly, demand for metal can-type cells as battery cells applied to battery packs for vehicles is increasing.

The process of manufacturing a battery cell using a cylindrical battery can includes the steps of deep-drawing a metal sheet to form a circular bottom portion and a circular tubular sidewall portion connected thereto, accommodating an electrode assembly therein, and then covering the open end of the sidewall portion with a lead to finish it.

The method of covering the open end of the battery can with a lead and fixing the lead and the battery can may be performed by crimping or seam welding.

In the seam welding method, the perimeter of the front end of the sidewall portion of the battery can and the perimeter of the edge of the lead are butt-welded along the perimeter direction. Since the fixing structure is simple, it can lead to a significant volume of the electrode assembly that may be accommodated inside the battery can. Therefore, the seam welding method is advantageous in securing electric capacity per volume of the battery can.

However, when filling the battery can with electrolyte and covering the open end of the battery can with a lead and welding it, there is a possibility that electrolyte vapor in the air at a certain concentration level or above may deteriorate or ignite when it comes into contact with the high temperature heat or plasma flame generated by welding.

For example, if the battery can and the lead are made of SUS, the surface temperature may rise to 1400° C., which is the melting point of SUS. This high temperature may cause ignition of the electrolyte.

Accordingly, when fixing the open end of the battery can and the lead by seam welding, a method may be utilized in which a battery can having an injection hole provided in the bottom portion or a lead having an injection hole is prepared, an electrode assembly is accommodated inside the battery can, the battery can and the lead are seam-welded, electrolyte is injected through the injection hole, and the injection hole is sealed after the completion of injection.

However, when injecting the electrolyte, if the high-pressure electrolyte comes into contact with the electrode assembly, it may cause physical damage, such as the separator at the core of the electrode assembly becoming loose. Therefore, a battery cell that reflects an inner diameter of an injection hole that not affecting the electrode assembly is required.

The use of ball or plug press-fitting, welding, or adhesive may be considered for sealing the injection hole. The design and finishing method of the injection hole must ensure a secure seal without damaging the electrode assembly, but there is currently no proper injection hole design and finishing method.

### DISCLOSURE

### Technical Problem

The present disclosure is designed to solve the problems of the related art, and therefore the present disclosure is directed to providing a lead having an injection hole configured so that the electrolyte does not affect the electrode assembly when the electrolyte is injected.

In addition, the present disclosure is directed to providing a lead that is sealed by welding a plug to an injection hole, but the lead is configured so that the welding heat during plug welding does not affect the electrode assembly and the plug is not damaged by the vaporization heat of the electrolyte.

In addition, the present disclosure is also directed to providing a lead in which the flatness with the electrode assembly is stably and evenly formed, thereby improving the welding quality with the electrode assembly.

In addition, the present disclosure is also directed to providing a lead by which various dimensions such as weld flatness with the electrode assembly, weld length, and injection hole diameter may be aligned.

In addition, the present disclosure is also directed to providing a battery cell including a sealing structure in which the above lead and a battery can are butt-welded.

In addition, the present disclosure is also directed to providing a battery pack including the battery cell.

In addition, the present disclosure is also directed to providing a vehicle including the battery pack.

However, the problems to be solved by the present disclosure are not limited to the above problems, and other problems not mentioned herein will be clearly understood by those skilled in the art from the following disclosure.

### Technical Solution

A battery cell according to an aspect of the present disclosure for solving the above problems may include an electrode assembly in which a first electrode and a second electrode as well as a separator interposed therebetween are wound based on a winding axis so that a winding center hole extending in a winding axis direction is formed at a center, a battery housing configured to accommodate the electrode assembly through an open end formed at one side, a lead configured to cover the open end and having an injection hole formed at a center, and a plug configured to be inserted into the injection hole and seal the injection hole, wherein the size of the injection hole may be smaller than the size of the winding center hole.

The lead may include an edge portion at a peripheral edge of the lead that is directly welded to the battery housing without beading or crimping of the battery housing.

The lead may be an integrated lead, such that the lead serves as a current collection plate and a lead, without a separate current collection plate electrically connected between the lead and the electrode assembly.

The diameter of the injection hole may be 50% to 80% of the diameter of the winding center hole of the electrode assembly.

The diameter of the injection hole may be 2 mm to 7 mm.

The diameter of the winding center hole may be 4 mm to 8 mm, and the diameter of the injection hole may be 2.5 mm to 6.5 mm.

The plug may include an insert portion extending into at least a part of the injection hole, and the plug has a welding portion at least partially welded to the lead.

The diameter of the insert portion may be smaller than the diameter of the injection hole, and a diameter of the welding portion may be larger than the diameter of the injection hole.

The welding portion of the plug may have a step at a peripheral edge portion thereof having a thickness that is less than a thickness of a remainder of the welding portion. The battery cell may also include a welding bead located in a space above the step, the welding bead not protruding above an upper surface of the remainder of the welding portion.

The lead may include a flat portion surrounding the injection hole, an edge portion at a peripheral edge of the lead and coupled to the battery housing, and at least one electrode coupling portion, each electrode coupling portion coupled to the electrode assembly, each electrode coupling portion located between the flat portion and the edge portion and recessed towards the electrode assembly relative to the flat portion and the edge portion, wherein the flat portion may be arranged to be spaced apart from the electrode assembly in the winding axis direction.

A separation distance in the winding axis direction between the flat portion and the electrode assembly may be 1.5 mm or more and 2.5 mm or less.

The plug coupling portion and the flat portion may be portions in which a step is formed in a radial direction.

The plug coupling portion may be a portion that extends inwardly in the radial direction from the flat portion, and may be formed to have a thinner thickness than the flat portion.

A thickness of the flat portion may be 0.55 mm or more and 0.65 mm or less, and a difference between the thickness of the plug coupling portion and the thickness of the flat portion may be 0.25 mm or more and 0.35 mm or less.

A distance between the flat portion and the electrode assembly may be arranged to be spaced apart most in the winding axis direction than other parts of the lead.

A distance between the plug coupling portion and the electrode assembly may be arranged to be spaced apart most in the winding axis direction than other parts of the lead.

The at least one electrode coupling portion may be a plurality of electrode coupling portions spaced apart from each other in a circumferential direction extending around the winding axis.

Each electrode coupling portion may have a bottom surface directly contacting and coupled to the electrode assembly.

The plurality of electrode coupling portions may include three electrode coupling portions.

The lead may include at least one bridge extending in a radial direction perpendicular to the winding axis and the circumferential direction from the flat portion towards the edge portion, each bridge extending between two adjacent ones of the electrode coupling portions.

The electrode coupling portions may be together distributed about the center of the lead in the circumferential direction, the electrode coupling portions being arranged symmetrically relative to the center of the lead.

The lead may include a plug coupling portion into which the plug is inserted and seated and coupled, the injection hole being formed at the center of the plug coupling portion.

The flat portion may include a bent portion recessed toward the injection hole, and each electrode coupling portion may include an extension portion extending toward the bent portion.

The lead may include a notched vent portion extending between each electrode coupling portion and the edge portion.

The lead may have a picking portion arranged between two adjacent ones of the electrode coupling portions and the edge portion, the picking portion having a picking area configured to be contacted by a picking device.

A battery pack according to an aspect of the present disclosure for solving the above problem may include the battery cell according to an aspect of the present disclosure and a pack housing configured to accommodate the battery cell.

A vehicle according to an aspect of the present disclosure for solving the above problem may include the battery pack according to an aspect of the present disclosure.

A method of manufacturing a battery cell according to an aspect of the present disclosure may include winding an electrode assembly including a first electrode, a second electrode, and a separator interposed between the first electrode and the second electrode, the electrode assembly being wound about a winding axis and having a winding center hole at a center of the electrode assembly extending along the winding axis. The method may also include inserting the electrode assembly into a battery housing accommodating through an open end formed at one side thereof, and welding a lead to the open end of the battery housing, the lead having an injection hole extending therethrough at a center thereof. The method may also include injecting an electrolyte into the battery housing through the injection hole, and inserting a plug into the injection hole to seal the injection hole. The injection hole may have a diameter that is smaller than a diameter of the winding center hole.

The lead may have a flat portion surrounding the injection hole, an edge portion at a peripheral edge of the lead and welded to the battery housing, and at least one electrode coupling portion, each electrode coupling portion coupled to the electrode assembly, each electrode coupling portion located between the flat portion and the edge portion and recessed towards the electrode assembly relative to the flat portion and the edge portion.

The lead may have an edge portion at a peripheral edge of the lead that is directly welded to the battery housing without beading or crimping of the battery housing.

The lead may be an integrated lead, such that the lead serves as a current collection plate and a lead, without a separate current collection plate electrically connected between the lead and the electrode assembly.

The method may also include, before the injecting of the electrolyte into the battery housing, inserting a welding rod through the injection hole and welding a lower current collection plate to a terminal at a closed end of the battery housing opposite from the open end.

The method may also include, after the welding of the of the lead to the open end of the battery housing, welding at least one electrode coupling portion of the lead to the electrode assembly.

### Advantageous Effects

According to one aspect of the present disclosure, through the design of the inner diameter of the injection hole of the lead of the present disclosure, it is possible to prevent the electrolyte from affecting the electrode assembly when the electrolyte is injected.

In addition, in the present disclosure, it is possible to provide a lead with improved welding quality to the electrode assembly by stably and evenly forming a flat surface with the electrode assembly.

In addition, in the present disclosure, it is possible to provide a lead by which various dimensions such as weld flatness, weld length, and injection hole diameter may be aligned with the electrode assembly.

According to one aspect of the present disclosure, by designing the structure of a portion surrounding the injection hole of the lead, welding heat may be prevented from being directly transferred to the electrode assembly when welding the plug and the lead.

In addition, in the present disclosure, it is possible to prevent thermal shock (loosening of the separator) occurring in the electrode assembly during welding of the plug and the lead and prevent physical damage (melting of the separator) to the electrode assembly.

In addition, in the present disclosure, by using a structure that is separated from the plug-lead welding portion by forging the portion surrounding the injection hole, it is possible to prevent plug welding defects caused by vaporization heat of the electrolyte around the injection hole.

However, the effects that may be obtained through the present disclosure are not limited to the above, and other effects not mentioned herein may be clearly understood by those skilled in the art from the following disclosure.

### DESCRIPTION OF DRAWINGS

The accompanying drawings illustrate some preferred aspects of the present disclosure and, together with the foregoing disclosure, serve to provide further understanding of the technical features of the present disclosure. Thus, the present disclosure is not to be construed as being limited to the drawings.

FIG. 1 is a perspective view showing the appearance of a battery cell according to an aspect of the present disclosure.

FIG. 2 is a cross-sectional view showing the battery cell of FIG. 1, taken along line A-A′.

FIG. 3 is an enlarged view showing a portion B of FIG. 2.

FIG. 4 is a plan view showing a lead according to an aspect of the present disclosure.

FIG. 5 is a side cross-sectional view showing a C-C′ cross-section of FIG. 4.

FIG. 6 is an enlarged side cross-sectional view showing a lead according to another aspect of the present disclosure.

FIG. 7 is a table showing the inner diameter of an injection hole, etc., compared to the winding center hole size of an electrode assembly according to an aspect of the present disclosure.

FIG. 8 is a perspective view showing a lead according to another aspect of the present disclosure.

FIG. 9 is a plan view showing a lead according to another aspect of the present disclosure.

FIG. 10 is a side cross-sectional view showing a D-D′ cross-section of FIG. 9.

FIG. 11 is a perspective view of a conventional detachable lead.

FIG. 12 is a table comparatively showing the vent pressure of the lead according to the present disclosure and the conventional detachable lead.

FIG. 13 is a partially cutaway perspective diagram illustrating a battery pack according to an aspect of the present disclosure.

FIG. 14 is a perspective diagram of a vehicle including the battery pack of FIG. 13.

### BEST MODE

Hereinafter, preferred aspects of the present disclosure will be described in detail with reference to the accompanying drawings. Prior to the description, it should be understood that the terms used in the specification and the appended claims should not be construed as limited to general and dictionary meanings, but rather interpreted based on the meanings and concepts corresponding to technical aspects of the present disclosure on the basis of the principle that the inventor is allowed to define terms appropriately for the best explanation.

Therefore, the description proposed herein merely represents some preferable examples for the purpose of illustration only, not intended to limit the scope of the disclosure, so it should be understood that other equivalents and modifications could be made thereto without departing from the scope of the disclosure.

For convenience of explanation, in this specification, the direction along the length direction of the winding axis of the electrode assembly wound in the form of a jelly-roll is referred to as a winding axis direction. In addition, the direction surrounding the winding axis is referred to as a circumferential direction or a peripheral direction. In addition, the direction approaching the winding axis or moving away from the winding axis is referred to as a radial direction. Among them, the direction approaching the winding axis is referred to as a centripetal direction, and the direction moving away from the winding axis is referred to as a centrifugal direction.

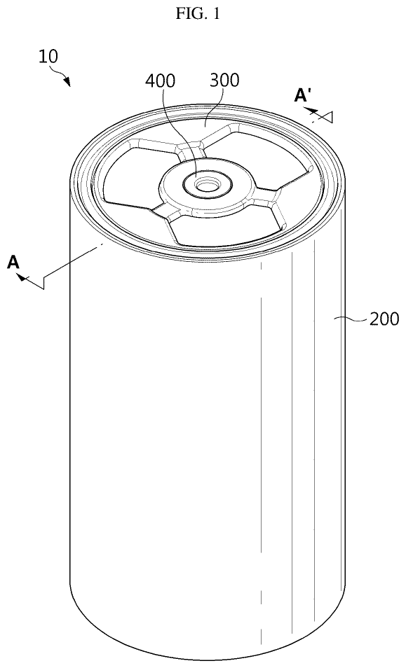

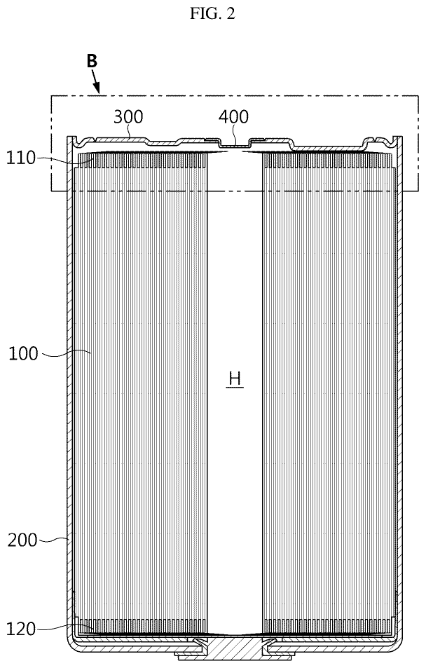

FIG. 1 is a perspective view showing the appearance of a battery cell 10 according to an aspect of the present disclosure. FIG. 2 is a cross-sectional view showing the battery cell 10 of FIG. 1, taken along line A-A′.

Referring to FIGS. 1 and 2, the battery cell 10 according to an aspect of the present disclosure may include an electrode assembly 100, a battery housing 200, a lead 300, and a plug 400.

Referring to FIG. 2, the electrode assembly 100 may have a first uncoated portion 110 and a second uncoated portion 120 at first and second opposite ends thereof. More specifically, the electrode assembly 100 may be in a jelly-roll shape in which the first electrode and the second electrode are wound around a winding axis with a separator interposed therebetween. Here, the first electrode and the second electrode may be formed in a sheet shape. An additional separator may be provided on an outer peripheral surface of the electrode assembly 100 for insulation from the battery housing 200. The structure of the electrode assembly 100 is not limited, but rather may have any winding structure well known in the art.

The first electrode may be a negative electrode plate and the second electrode may be a positive electrode plate. The negative electrode plate may have a negative electrode active material applied to one or both surfaces thereof, and a first uncoated portion 110 on which the negative electrode active material is not applied may be formed at an end of the negative electrode plate. The first uncoated portion 110 may be exposed to the outside of the separator while forming a plurality of winding turns about the center of the electrode assembly 100, such that the first uncoated portion 110 itself may be used as an electrode tab. The positive electrode plate may have a positive electrode active material applied to one or both surfaces thereof, and a second uncoated portion 120 on which the positive electrode active material is not applied may be formed at an end of the positive electrode plate. The second uncoated portion 120 may be exposed to the outside of the separator while forming a plurality of winding turns about the center of the electrode assembly 100, such that the second uncoated portion 120 itself may be used as an electrode tab. That is, the positive electrode plate and the negative electrode plate may each include an uncoated portion on which an active material is not coated, and the uncoated portion may be positioned along a long side of the respective positive and negative electrode plate that extends in the circumferential direction when the electrode assembly is wound. In addition, the first uncoated portion 110 and the second uncoated portion 120 may be configured to face in opposite directions. The first uncoated portion 110 may be accommodated inside the battery housing 200 so as to be positioned at one end in the winding axis direction, and the second uncoated portion 120 may be positioned at the other end in the winding axis direction. Here, the positive electrode active material coated on the positive electrode plate and the negative electrode active material coated on the negative electrode plate may be used without limitation as long as they are active materials known in the art.

For example, the first uncoated portion 110 and the second uncoated portion 120 may have notches formed therein at a predetermined interval along the circumferential direction to form notching tabs in the shape of a flag. In the jelly-roll type electrode assembly 100, the notching tabs may be bent in the radial direction and flattened. The notching tabs may be bent inwardly or outwardly in the radial direction. The notching tabs may be bent one by one during the process of forming the jelly-roll type electrode assembly 100 by winding the laminate. Alternatively, the notching tabs may be bent all at once after the jelly-roll type electrode assembly 100 is formed by winding the laminate. The notching tabs of the first uncoated portion 110 and the notching tabs of the second uncoated portion 120, which are folded and overlapped in the radial direction, may define a plane that is substantially perpendicular to the axial direction at each of the axial ends of the electrode assembly 100.

Referring to FIGS. 1 and 2, the battery housing 200 may be configured to accommodate the electrode assembly 100. The battery housing 200 may have an open end formed at one side. The battery housing 200 may be a generally cylindrical receiver having an open end formed at one side. For example, the electrode assembly 100 may be accommodated inside the battery housing 200 such that the first uncoated portion 110 faces the open end. Specifically, the battery housing 200 may include a sidewall portion, a bottom portion connected to one axial end of the sidewall portion, and an open end provided at the other axial end of the sidewall portion. The sidewall portion and the bottom portion of the battery housing 200 may be formed integrally. The bottom portion has a generally flat shape. The sidewall portion may be cylindrical, connected to the bottom portion, and extending in the axial direction. The side of the sidewall portion that is not connected to the bottom portion may be defined as the open end of the battery housing 200. The open end may be formed at a portion facing the bottom portion of the battery housing 200. Accordingly, the electrode assembly 100 may be accommodated through the open end formed in the battery housing 200.

The conventional battery housing 200 sometimes further includes a beading portion formed at an end adjacent to the open end and a crimping portion formed on the beading portion. However, the battery housing 200 of the present disclosure may not have a beading crimping structure formed on the sidewall portion. That is, the sidewall portion of the battery housing 200 of the present disclosure may not be recessed radially inward. That is, the battery housing 200 of the present disclosure may be configured to have a constant radius over the entire area of the sidewall portion.

According to this structure, by excluding the beading crimping structure in the cylindrical battery cell 10, various process errors that may occur due to the beading crimping structure may be prevented. In addition, process simplification may be achieved by omitting the beading and crimping processes. Moreover, since the beading crimping structure is not formed, it is possible to avoid the associated increase in the dead space within the battery in the winding axis direction and the corresponding decrease in energy density. Therefore, the battery cell 10 according to the present disclosure may have a higher internal capacity more than a battery cell using the beading and crimping methods and having the same external shape. That is, the energy density of the battery cell 10 may be improved according to the structure of the present disclosure.

The battery housing 200 may include a conductive metal material. The material of the battery housing 200 may include a conductive metal, such as aluminum, steel, or stainless steel. For example, the bottom portion and the sidewall portion may be manufactured by forming a metal sheet having nickel plated on the surface of steel using a deep drawing process, and trimming the front end of the sidewall portion with a punch while holding it with a blank holder. However, the material and manufacturing method of the battery housing 200 are not limited thereto.

Referring to FIGS. 1 and 2, the lead 300 may be configured to cover the open end formed at one side of the battery housing 200. The lead 300 may be configured to have, for example, an approximate plate shape. The lead 300 may be coupled to the open end of the battery housing 200. According to one aspect of the disclosure, as shown in FIG. 2, the lead 300 may be in contact with an inner surface of an upper edge of the open end of the battery housing 200. According to another aspect, although not illustrated in the drawings, the lead 300 may be seated on an upper edge of the open end of the battery housing 200.

The contact point of the open end of the battery housing 200 and the lead 300 may be coupled. For example, the coupling point between the open end of the battery housing 200 and the lead 300 may be coupled by welding. For example, the lead 300 may be coupled to the battery housing 200 using butt welding. Therefore, the battery cell 10 may have a larger internal capacity with the same external shape than a battery cell using the beading and crimping methods. Therefore, the energy density of the battery cell 10 may be increased. However, the battery housing 200 and the lead 300 may be coupled by joining other than welding, and the coupling manner is not limited thereto. By coupling the battery housing 200 and the lead 300, the battery cell 10 may be guaranteed to be sealed.

The lead 300 may be made of a metal material. Therefore, the lead 300 may have conductivity. For example, the lead 300 may include an aluminum material. The lead 300 may be electrically connected to battery housing 200. Meanwhile, since the battery housing 200 is also made of a metal having conductivity, the lead 300 coupled to the battery housing 200 may also be configured to have the same polarity as the battery housing 200.

The thickness of lead 300 may be approximately 0.5 mm or more and 2 mm or less. For example, the thickness of lead 300 may be approximately 1 mm. However, the thickness of lead 300 may not be constant and is not limited.

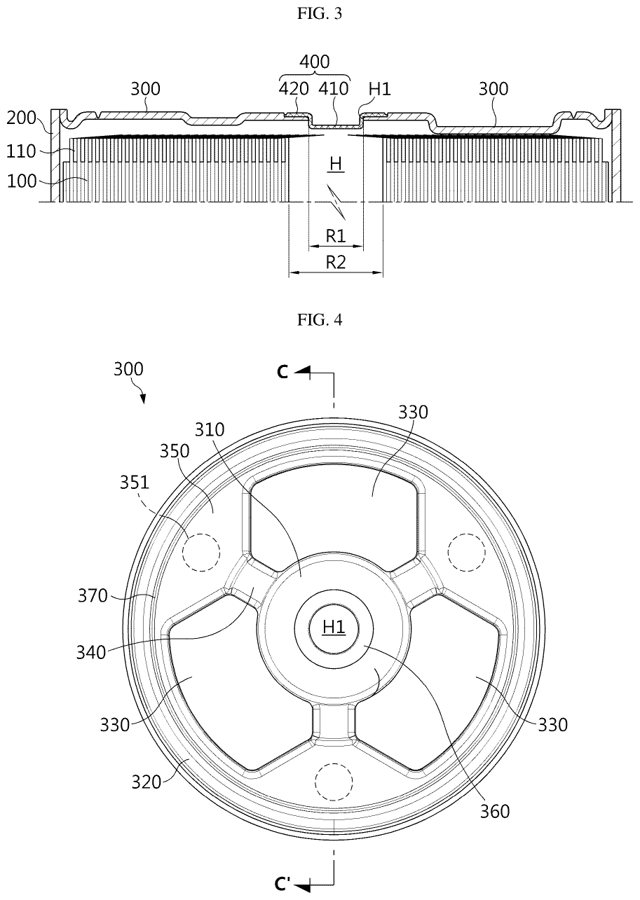

FIG. 3 is an enlarged view showing a portion B of FIG. 2.

Referring to FIGS. 1 to 3, the lead 300 may have an injection hole H1 formed in at least a part of the lead. The injection hole H1 may be formed in the center of the lead 300. At this time, the injection hole H1 may be blocked by a plug 400, explained later. For example, the plug 400 may be press-fitted into the injection hole H1. Since the injection hole H1 is blocked by the plug 400, the battery cell 10 may secure hermetical sealing. Also, the plug 400 may seal the injection hole H1 by welding.

The injection hole H1 may serve as an electrolyte injection port, for example. The center of the injection hole H1 may coincide with the center of the winding center hole H of the electrode assembly 100. That is, in the winding axis direction, the injection hole H1 of the lead 300 may be located above the winding center hole H of the electrode assembly 100.

Meanwhile, the injection hole H1 may be configured to discharge gas generated during the pre-charge process, explained later. That is, after a degassing process in which all gases generated during the pre-charge process are discharged through the injection hole H1, the plug 400 may be configured to be coupled into the injection hole H1. Accordingly, the swelling phenomenon of the battery cell 10 may be reduced.

Referring to FIGS. 1 to 3, the plug 400 may be configured to seal the injection hole H1. That is, the plug 400 may be configured to be inserted into the injection hole H1. The plug 400 may penetrate the injection hole H1. By inserting the plug 400 into the injection hole H1 of the lead 300, the sealing of the battery cell 10 may be performed. The plug 400 may penetrate the injection hole H1 formed in the lead 300 to seal the exterior and interior of the battery housing 200 and prevent leakage of the electrolyte.

With this structure, the beading and crimping processes may be omitted, thereby achieving process simplification. Moreover, it is possible to avoid the increase in dead space within the battery in the winding axis direction of the electrode assembly 100 as a result of the beading and crimping structure, which thus lowers the energy density. That is, according to the structure of the present disclosure, the energy density of the battery cell 10 may be improved.

As shown in FIG. 3, the plug 400 may include an insert portion 410 configured to be inserted into at least a part of the injection hole H1, and a welding portion 420 configured to be mutually welded with at least a part of the lead 300. For example, the diameter of the insert portion 410 of the plug 400 may be approximately 3 mm or more and 7 mm or less. For example, the diameter of the insert portion 410 of the plug 400 may be approximately 5 mm or more and 5.50 mm or less. By having the insert portion 410, the plug 400 may be maintained in a state of being press-fitted and fixed into the injection hole H1 even before welding, and the plug 400 is prevented from being detached from the injection hole H1 while being transferred to a welding device. For example, the diameter of the welding portion 420 of the plug 400 may be approximately 6 mm or more and 12 mm or less. For example, the diameter of the welding portion 420 of the plug 400 may be approximately 9 mm or more and 9.5 mm or less. For example, the thickness of the plug 400 in the winding axis direction may be 0.8 mm or more and 3 mm or less. For example, the thickness of the plug 400 in the winding axis direction may be 1.50 mm or more and 1.70 mm or less. For example, the thickness of the plug 400 may be 0.1 mm or more and 0.5 mm or less. For example, the thickness of the plug 400 may be 0.3 mm.

According to one aspect, the edge portion of the welding portion 420 of the plug 400 may have a step. For example, the portion formed on the edge portion of the welding portion 420 of the plug 400 may have a thinner thickness than the remaining portion. For example, the thickness of the edge portion of the welding portion 420 of the plug 400 may be 0.05 mm or more and 0.3 mm or less. For example, the thickness of the edge portion of the welding portion 420 of the plug 400 may be 0.2 mm. According to the aspect of the present disclosure, when welding the welding portion 420, the welding bead may be accommodated in the space where the step is formed, and the welding bead does not protrude to the surface, thereby ensuring flatness.

The injection hole H1 may be configured to allow an electrolyte to be injected. The injection hole H1 may be a hole into which the electrolyte is injected and also a hole through which a welding rod passes. For example, in the battery cell 10, a current collection plate (e.g., a positive electrode current collection plate) and a rivet-shaped terminal may be arranged on the opposite side of the battery cell 10 from the injection hole H1, and a welding rod for welding and coupling the current collection plate and the terminal may be inserted through the injection hole H1 into the winding center hole H of the electrode assembly 100. The injection hole H1 may be located approximately at the center of the lead 300.

The size of the injection hole H1 may be smaller than the size of the winding center hole H of the electrode assembly 100. The inner diameter R1 of the injection hole H1 may be larger than the diameter of the welding electrode in order to avoid interference of the welding electrode. In addition, the inner diameter R1 of the injection hole H1 may be smaller than the inner diameter R2 of the winding center hole H of the electrode assembly 100 in order to ensure stable injection of electrolyte, etc.

For example, the size of the injection hole H1 may be approximately 50% to 80% of the size of the winding center hole H of the electrode assembly 100. For example, the size of the injection hole H1 may be approximately 60% to 80% of the size of the winding center hole H of the electrode assembly 100. For example, the size of the injection hole H1 may be approximately 75% of the size of the winding center hole H of the electrode assembly 100.

According to an aspect of the disclosure, the inner diameter R1 of the injection hole H1 may be approximately 2 mm or more and 7 mm or less. For example, the inner diameter of the injection hole H1 may be approximately 5 mm or more and 5.5 mm or less.

According to this structure, when the electrolyte is injected through the injection hole H1, the electrode assembly 100 may not be directly affected. Specifically, when the electrolyte is injected, the high-pressure electrolyte may not directly contact the inner surface of the winding center hole H of the electrode assembly 100. Accordingly, the electrode assembly 100 may not be subjected to physical impact and/or damage. For example, the phenomenon of the separator of the electrode assembly 100 loosening due to the electrolyte contacting the electrode assembly 100 may be prevented.

The diameter of the insert portion 410 of the plug 400 may be smaller than the inner diameter R1 of the injection hole H1, and the diameter of the welding portion 420 may be larger than the inner diameter R1 of the injection hole H1.

According to this structure, when the plug 400 is pressed into the injection hole H1, the plug 400 moves downward. At this time, the electrode assembly 100, etc., may be prevented from being damaged by the plug 400 that has moved downward. That is, even if the plug 400 is pressed downward, since the plug 400 enters the inside of the winding center hole H of the electrode assembly 100, the folded surface or electrode tab of the electrode assembly 100 may not be affected.

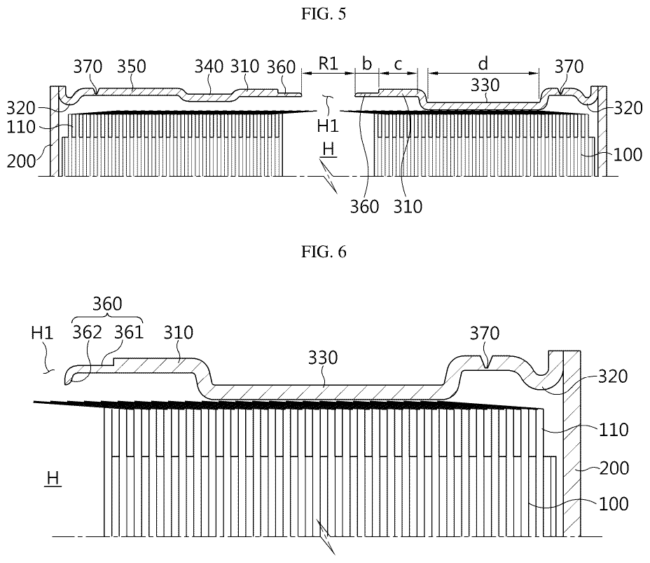

FIG. 4 is a plan view showing a lead according to an aspect of the present disclosure. FIG. 5 is a side cross-sectional view showing a C-C′ cross-section of FIG. 4.

Referring to FIGS. 4 and 5, the lead 300 according to an aspect of the present disclosure may further include a flat portion 310, an edge portion 320, and a plurality of electrode coupling portions 330.

The flat portion 310 may surround the injection hole H1. The flat portion 310 may surround the injection hole H1 along a roughly circumferential direction. The flat portion 310 may be provided in a shape in which at least a portion is flat.

Meanwhile, the length (c) of the flat portion 310 may be formed appropriately to secure stable flatness. For example, the length (c) may be preferably 3 mm or more. If the length (c) is less than 3 mm, forming of the flat portion 310 may be difficult.

The flat portion 310 and the electrode assembly 100 may be arranged to be spaced apart from each other in the winding axis direction. That is, the flat portion 310 may be arranged higher in the winding axis direction than the electrode coupling portion 330. For example, the separation distance in the winding axis direction between the flat portion 310 and the electrode assembly 100 may be about 1.5 mm or more and 2.5 mm or less. For example, the separation distance between the flat portion 310 and the electrode assembly 100 may be about 2 mm. Moreover, since the height in the winding axis direction of the flat portion 310 adjacent to the welding portion of the lead 300 and the plug 400 is high, welding heat may be blocked from being directly transferred to the electrode assembly 100. Therefore, damage such as loosening of the separator of the electrode assembly 100 or melting of the separator of the electrode assembly 100 due to thermal or physical shock caused by welding heat may be prevented.

The edge portion 320 may be formed at the edge of the lead 300 so as to be coupled to the battery housing 200. The edge portion 320 may be coupled to an open end formed at one side of the battery housing 200 by a press-fitting method. The edge portion 320 may be coupled to the battery housing 200 by being press-fitted to one side of the battery housing 200 and then welding. A cross section of the edge portion 320 may be approximately U-shaped. A bottom of the edge portion 320 (the side closest to the electrode assembly 100 along the winding axis direction) may be spaced apart from the electrode assembly 100 along the winding axis direction, as shown in the figures.

The electrode coupling portion 330 may be coupled with the electrode assembly 100. The electrode coupling portion 330 may be coupled with the electrode assembly 100 by welding. The bottom surface (the surface facing the electrode assembly 100) of the electrode coupling portion 330 may be coupled face-to-face with the electrode assembly 100. The bottom surface of the electrode coupling portion 330 may be coupled with the first uncoated portion 110 (foil tab) of the electrode assembly 100.

The electrode coupling portion 330 may be arranged between the flat portion 310 and the edge portion 320. That is, the flat portion 310, the electrode coupling portion 330, and the edge portion 320 may be arranged sequentially along the radial direction. A plurality of the electrode coupling portions 330 may be provided, and the plurality of electrode coupling portions 330 may be arranged to be spaced apart from each other. For example, the plurality of electrode coupling portions 330 may be arranged to be spaced apart from each other in the circumferential direction.

The plurality of electrode coupling portions 330 may be formed as a depression recessed along the winding axis direction. Specifically, the electrode coupling portions 330 may be formed to be recessed downwardly toward the electrode assembly 100. The bottom surface of the electrode coupling portion(s) 330 may be positioned closer to the electrode assembly 100 than the remaining bottom surfaces of the lead 300. In that way, when the electrode coupling portions 330 are coupled with the electrode assembly 100, the remaining portions of the lead 300 other than the electrode coupling portion 330 may be spaced apart from an upper end of the electrode assembly 100.

In one example, the lead 300 may be formed by stamping a piece of sheet metal so that the various features of the lead 300, including the electrode coupling portions 330, are recessed downwardly along the winding axis direction. By having the plurality of electrode coupling portions 330 spaced apart from each other, the recessed electrode coupling portions 330 may collectively define a more stable flat surface with the electrode assembly 100. The lead 300 according to an aspect of the present disclosure may improve welding quality with the electrode assembly 100.

Meanwhile, since the lead 300 according to the present disclosure may be coupled to the battery housing 200 to cover the open end of the battery housing 200 and at the same time is electrically connected to the electrode assembly 100, a separate current collection plate, such as a negative electrode current collection plate, need not be provided. That is, the lead 300 according to the present disclosure may be provided as a so-called integrated lead 300 that may also perform the function of a current collection plate.

The electrode coupling portion 330 may extend between the flat portion 310 and the edge portion 320. Specifically, the electrode coupling portion 330 may extend centripetally toward the flat portion 310, and the electrode coupling portion 330 may extend radially toward the edge portion 320. As a result, the electrode coupling portion 330 may have a relatively long length (d), which is a welding length (LFW, Lid Foil tab welding) between the electrode coupling portion 330 and the first uncoated portion 110 (foil tab), which may thus reduce the internal resistance of the battery cell. For example, the maximum length (d) in the radial direction of the electrode coupling portion 330 may be approximately 6 mm or more and 15 mm or less. For example, the maximum length (d) in the radial direction of the electrode coupling portion 330 may be approximately 12 mm. For example, the maximum length (d) in the radial direction of the electrode coupling portion 330 may be approximately 9 mm.

The electrode coupling portion 330 may be provided in three discrete sections. When the electrode coupling portion 330 is provided in three sections, the plurality of electrode coupling portions 330 may easily form a single plane, so that a stable flatness with the electrode assembly 100 may be more easily secured. In other examples (not shown), the electrode coupling portion 330 may be provided in other numbers of spaced apart pieces, including one, two, four, five, six, eight, or ten, among others. The sections of the electrode coupling portion 330 may be distributed circumferentially about the winding axis of the electrode assembly 100. The sections of the electrode coupling portion 330 may be spaced apart from one another in a circumferential direction of the electrode assembly 100, the circumferential direction being perpendicular to a radial direction extending outward from the winding axis. The pieces of the electrode coupling portion 330 may be distributed symmetrically in the circumferential direction about the winding axis of the electrode assembly 100.

The lead 300 according to an aspect of the present disclosure may further include at least one bridge 340. A plurality of bridges 340 may be provided, such as, for example, three bridges 340. The bridge 340 may extend in a radial direction from the flat portion 310. Each bridge 340 may be formed to partition two adjacent electrode coupling portions 330. The bridge 340 may extend from the flat portion 310 toward the edge portion 320. Alternatively, the bridge 340 may extend from the flat portion 310 toward the picking portion 350, explained later. The number of bridges 340 may be equal to the number of sections of the electrode coupling portion 330 (e.g., two, four, five, six, eight, or ten bridges, among others). The bridges 340 may be spaced apart from one another in a circumferential direction of the electrode assembly 100, and the bridges may be distributed symmetrically in the circumferential direction about the winding axis of the electrode assembly.

By the bridges 340, the plurality of electrode coupling portions 330 may be more reliably partitioned and separated. The bridges 340 may reinforce the rigidity of the lead 300.

Meanwhile, the upper surface of the bridge 340 may be formed at a height higher than the upper surface of the electrode coupling portion 330, but lower than the upper surface of the flat portion 310. If the bridge 340 is formed in this manner, the rigidity of the lead 300 may be further strengthened.

The plurality of electrode coupling portions 330 may be formed and arranged radially rotationally symmetrically with respect to the center of the lead 300. The electrode coupling portions 330 may be formed in the same shape and arranged to form an equiangular angle with respect to the lead 300. If the plurality of electrode coupling portions 330 are formed and arranged symmetrically in this way, stable flatness between the lead 300 and the electrode assembly 100 may be more easily secured, and the electrical stability of the battery cell may also be improved.

Referring to FIG. 6, the lead 300 according to an aspect of the present disclosure may further include a plug coupling portion 360. The plug 400 may be inserted, seated and coupled into the plug coupling portion 360. An injection hole H1 may be formed at the center of the plug coupling portion 360. The plug 400 may be configured to seal the injection hole H1. The plug coupling portion 360 may be a portion extending inwardly from the flat portion 310 in the radial direction. The plug coupling portion 360 may be formed to have a thinner thickness than the flat portion 310. That is, the plug coupling portion 360 and the flat portion 310 may be portions in which a step is formed in the radial direction.

The step may be formed by forging. For example, the thickness of the flat portion 310 may be approximately 0.55 mm or more and 0.65 mm or less, and the difference between the thickness of the plug coupling portion 360 and the thickness of the flat portion 310 may be approximately 0.25 mm or more and 0.35 mm or less. For example, the thickness of the flat portion 310 may be approximately 0.6 mm, and the difference between the thickness of the plug coupling portion 360 and the thickness of the flat portion 310 may be 0.3 mm. According to the present disclosure, a structure on which the welding portion 420 of the plug 400 may be seated may be formed by forging the area around the injection hole H1. In addition, by forming the welding portion 420 to be spaced apart from the injection hole H1, welding defects of the plug 400 caused by vaporization heat of electrolyte around the injection hole may be prevented.

Meanwhile, as the length (b) of the plug coupling portion 360 formed from the injection hole H1 to the end of the flat portion 310 increases, the weldability of the welding portion 420 of the plug 400 and the seating portion 361 may be improved. This is because the distance from the injection hole H1 to the welding position becomes longer, thereby preventing a problem of welding quality deterioration due to the electrolyte. The length (b) may be designed to prevent welding defects of the plug 400 due to vaporization heat of the electrolyte. For example, the length (b) in the radial direction of the plug coupling portion 360 may be 1 mm or more and 3 mm or less. For example, the length (b) in the radial direction of the plug coupling portion 360 may be 2 mm.

If the lead 300 further includes a plug coupling portion 360 as above, the coupling property between the plug 400 and the lead 300 is improved, and the injection hole H1 may be effectively sealed.

The lead 300 according to the present disclosure may further include a picking portion 350. The picking portion 350 may be arranged between two adjacent electrode coupling portions 330 and the edge portions 320. A picking area 351 may be formed in the picking portion 350. The picking area 351 may be engaged by a picking device. The diameter of the picking area 351 may be formed to be, for example, about 4 mm. The picking area 351 may be a flat section of the lead 300 that is configured to be suctioned and then lifted and moved by a vacuum suction arm of a picking device, for example.

In the case where the lead 300 according to the present disclosure is equipped with the picking portion 350, the picking equipment may not come into contact with the electrode coupling portion 330, and thus foreign substances, etc. may be prevented from entering the electrode coupling portion 330 from the picking equipment, etc., and the lead 300 may be stably held and transported during the battery cell assembly process.

The flat portion 310 and the electrode assembly 100 may be arranged to be spaced apart from each other in the winding axis direction. The separation distance between the flat portion 310 and the electrode assembly 100 in the winding axis direction may be larger compared to the spacing between the electrode assembly 100 and other portions of the lead 300. That is, the height of the flat portion 310 above the electrode assembly 100 in the winding axis direction may be highest compared to other portions of the lead 300. For example, the separation distance between the flat portion 310 and the electrode assembly 100 may be longer than the separation distance between the upper surface of the edge portion 320 and the electrode assembly 100. Similarly, the separation distance between the plug coupling portion 360 and the electrode assembly 100 in the winding axis direction may be larger compared to other portions of the lead 300. According to the present disclosure, since the height in the winding axis direction of the flat portion 310 is relatively high, the welding heat during welding of the lead 300 and the plug 400 may be blocked from being directly transferred to the electrode assembly 100. Accordingly, physical damage, such as melting of the separator of the electrode assembly 100 due to the welding heat, may be prevented.

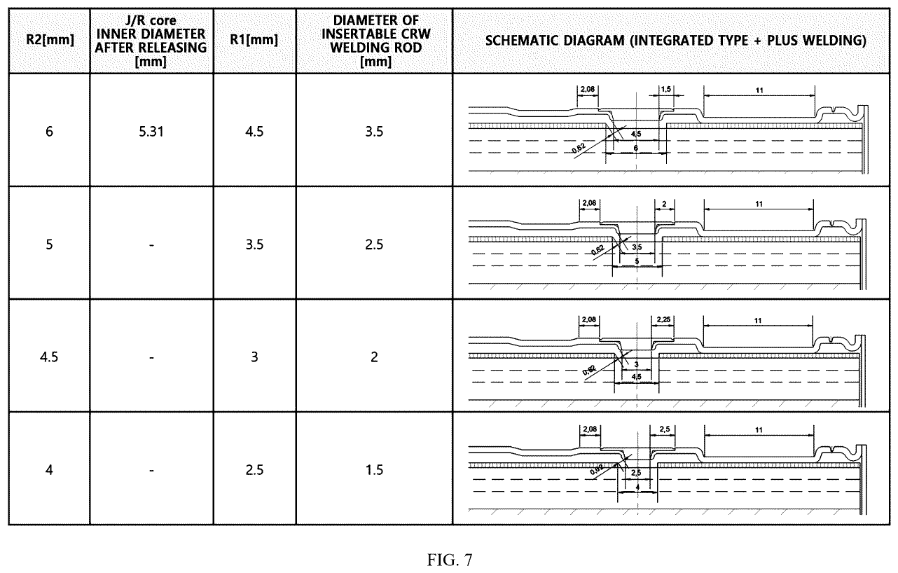

FIG. 6 is an enlarged side cross-sectional view showing a lead according to another aspect of the present disclosure. FIG. 7 is a table showing the inner diameter of an injection hole, etc., compared to the winding center hole size of an electrode assembly according to an aspect of the present disclosure.

Referring to FIG. 6, the plug coupling portion 360 of the lead 300 according to another aspect of the present disclosure may include a guide portion 362 and a seating portion 361. The seating portion 361 may be a portion extending inwardly in the radial direction from the flat portion 310. The seating portion 361 may be formed to have a thinner thickness than the flat portion 310. That is, the seating portion 361 and the flat portion 310 may be portions in which a step is formed in the radial direction. A plug 400 may be seated on the seating portion 361. The plug 400 may include a welding portion 420 to be seated on the seating portion 361.

The guide portion 362 may be a portion extending inwardly from the seating portion 361 into the battery housing 200. At least a part of the guide portion 362 may be inclined from the seating portion 361, such as by forming an oblique angle relative to the seating portion 361 or by following a curved or other path that extends radially inwardly while also extending downwardly along the winding axis direction. The plug 400 may be inserted into the guide portion 362. The plug 400 may have an insert portion 410 formed to be inserted along the guide portion 362. The insert portion 410 may be coupled to the guide portion 362 in a press-fitting manner. An injection hole H1 may be formed at the inside of the guide portion 362, and when the insert portion 410 is inserted into the guide portion 362 along the guide portion 362, the injection hole H1 may be sealed. The welding portion 420 may be a shape extending in a radial direction from the insert portion.

FIG. 7 shows the inner diameter of the electrode assembly 100 after being released within the housing 200, reflecting the inner diameter R2 of each winding center hole H, the inner diameter R1 of the injection hole H1, and the diameter of the welding rod that can be inserted into the injection hole H1. In this way, the inner diameter R1 of the injection hole H1 may be designed in consideration of the diameter of the welding rod and the process margin.

According to one aspect, the inner diameter R1 of the injection hole H1 may be approximately 2 mm or more and 7 mm or less. For example, when the inner diameter R2 of the winding center hole His 4 mm or more and 8 mm or less, the inner diameter R1 of the injection hole H1 may be 2.5 mm or more and 6.5 mm or less. For example, when the inner diameter R2 of the winding center hole H is 6 mm, the inner diameter R1 of the injection hole H1 may be 4.5 mm.

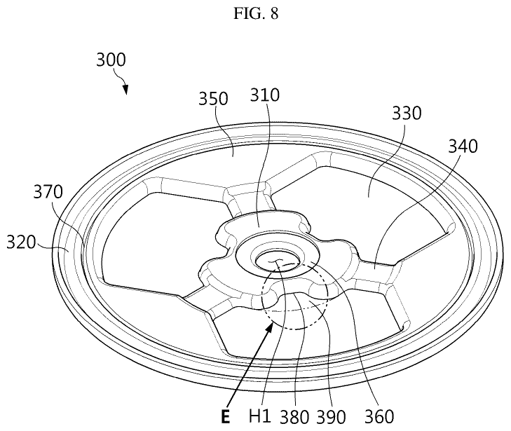

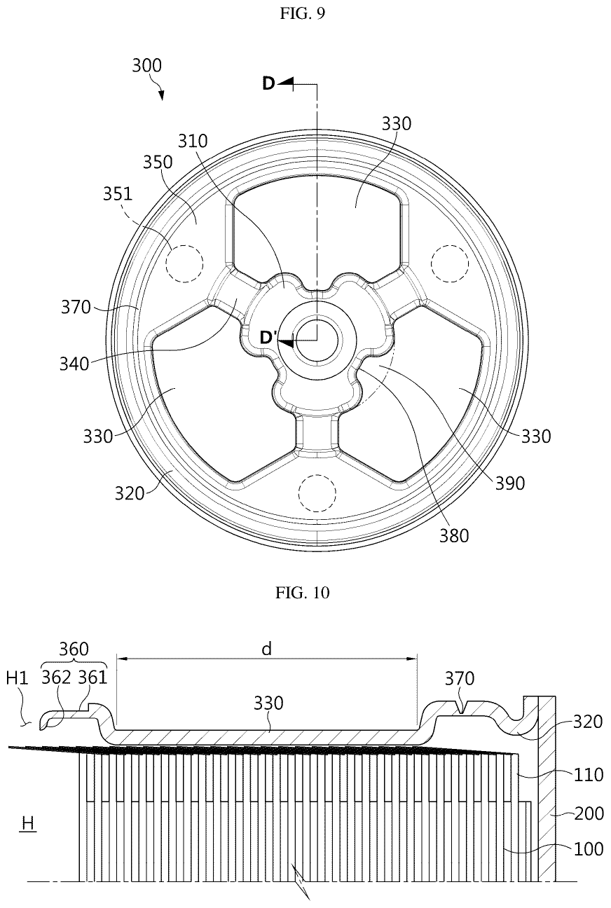

FIG. 8 is a perspective view showing a lead 300 according to another aspect of the present disclosure, FIG. 9 is a plan view showing a lead 300 according to another aspect of the present disclosure, and FIG. 10 is a side cross-sectional view showing a D-D′ cross-section of FIG. 9.

Referring to FIGS. 8 to 10, the lead 300 according to another aspect of the present disclosure may include a bent portion 380, and the electrode coupling portion 330 may include a corresponding extension portion 390.

Referring to a portion indicated as E in FIG. 8, the bent portion 380 may be formed to be recessed into the flat portion 310 toward the injection hole H1 from the electrode coupling portion 330. Correspondingly, the extension portion 390 may be formed to extend into the bent portion 380. The extension portion 390 may extend toward the injection hole H1 to the same extent that the bent portion 380 is recessed.

If the flat portion 310 and the electrode coupling portion 330 are provided with the bent portion 380 and the extension portion 390 as above, respectively, the length (d), which is the welding length between the electrode coupling portion 330 and the electrode assembly 100, may be further increased, so that the internal resistance of the battery cell 10 may be further reduced. For example, referring to FIG. 5, if the lead 300 does not have the bent portion 380 and the extension portion 390, the length (d) may be about 9 mm. For example, referring to FIG. 8, if the lead 300 has the bent portion 380 and the extension portion 390, the length (d) may be longer, such as about 12 mm

In addition, due to the recessed structure of the bent portion 380, a sufficient length (c) of the remaining portion of the flat portion 310 (excluding the bent portion 380) may still be provided. In addition, the inner diameter R1 and/or the length (b) of the injection hole H1 may still be provided despite the presence of the bent portion 380. In addition, the rigidity of the lead 300 may be further reinforced. In addition, since the internal resistance of the battery cell 10 may be reduced, the width (in the circumferential direction) of the electrode coupling portion 330 may be reduced, in order to provide additional area for the picking portion 350.

If the length (b), the length (c), and the length (d) are designed as above, various dimensions of the lead 300, such as the weld flatness, the weld length, and the diameter of the injection hole H1 of the lead 300, may be provided.

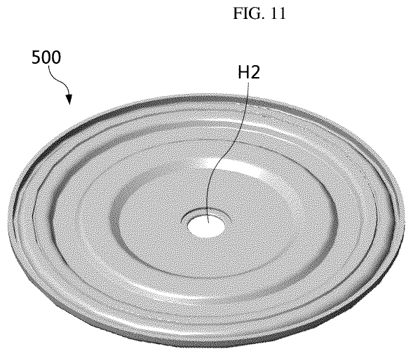

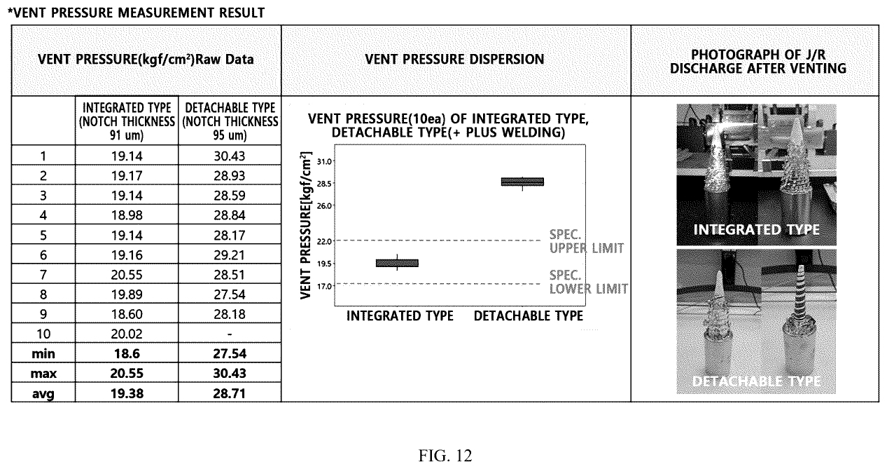

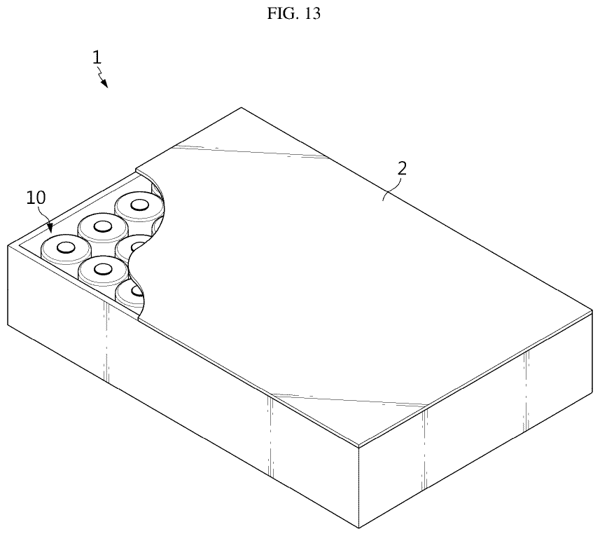

FIG. 11 is a perspective view of a conventional detachable lead, and FIG. 12 is a table comparatively showing the vent pressure of the lead according to the present disclosure and the conventional detachable lead.

Referring to FIGS. 5 to 10, the lead 300 according to the present disclosure may further include a vent portion 370. The vent portion 370 may be formed between the electrode coupling portion 330 and the edge portion 320. The vent portion 370 may be ruptured by the internal pressure of the high-temperature venting gas when a thermal event occurs in the battery cell 10, thereby allowing the venting gas to be discharged to the outside from the battery cell 10.

Since the vent portion 370 is provided in the lead 300 and does not occupy a separate space, energy density may be further secured. The vent portion 370 may be ruptured when the pressure inside the battery housing 200 exceeds a critical value. The vent portion 370 may be formed on one or both opposing surfaces of the lead 300. The vent portion 370 may be formed by notching along a circumferential direction on the inner side of the edge portion 320 of the lead 300. The vent portion 370 may form a continuous or discontinuous circular pattern, a linear pattern, or other patterns on the surface of the lead 300. For example, the vent portion 370 may be formed in an approximately circular ring shape having a predetermined width. The circular ring-shaped vent portion 370 may have the same center as the center of the lead 300. For example, the vent portion 370 may be implemented as a thin-walled portion in which both surfaces of the lead 300 are notched. If the vent portion 370 is formed in the lead 300, venting gas may be easily discharged from the battery cell 10.

In particular, referring to FIG. 12, it may be found that the vent pressure of the lead 300 according to the present disclosure is lower than that of a conventional battery cell. The conventional lead 500 shown in FIG. 11 may be a detachable lead including a separate current collection plate (not shown) positioned below and used in conjunction with the lead. The conventional lead shown in FIG. 11 may be formed in a single flat shape with no bending as a whole along the periphery of injection hole H2.

FIG. 12 shows a comparative experimental example of the vent pressure of the lead (integrated type) 300 according to the present disclosure and the conventional lead (detachable type) shown in FIG. 11. Here, the vent pressure may be understood as the size of the internal pressure of the battery cell at which the vent portion 370 begins to rupture.

According to FIG. 12, it may be found that the notch thickness of the vent portion 370 of the lead 300 according to the present disclosure and the thickness of the vent portion of the conventional lead are provided at almost similar levels, 91 μm and 95 um, respectively. However, the vent pressure of the lead 300 according to the present disclosure is measured to have an average of 19.4 kgf/cm² (dispersion 2.05 kgf/cm²), which is lower than the average of the vent pressure of the conventional lead, 28.7 kgf/cm² (dispersion 2.92 kgf/cm²). That is, the lead 300 according to the present disclosure may have a thickness of the vent portion 370 similar to that of the conventional lead, thereby having high formability of the vent portion 370 and having the advantage of rupturing at a lower vent pressure.

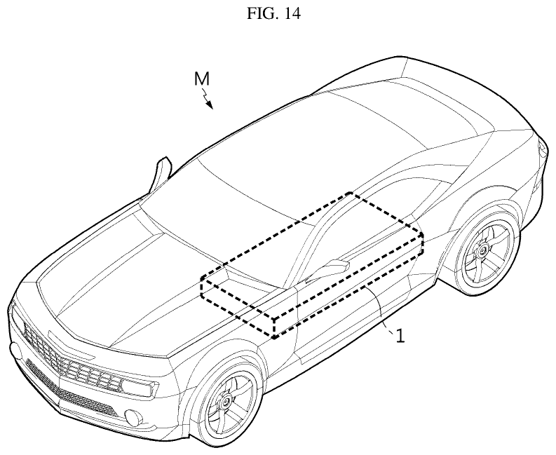

FIG. 13 is a partially cutaway perspective diagram illustrating a battery pack according to an aspect of the present disclosure. FIG. 14 is a perspective diagram of a vehicle including the battery pack of FIG. 13.

Referring to FIG. 13, the battery pack 1 according to the present disclosure may include at least one battery cell 10 according to the present disclosure described above. In addition, the battery pack 1 according to the present disclosure may include a pack housing 2 capable of accommodating the at least one battery cell 10. The battery pack 1 may be configured using a plurality of battery modules (not shown), which are an intermediate form of assembly between a battery cell and a battery pack. That is, a battery module may contain a plurality of battery cells 10, and a plurality of battery modules may be arranged to make up the battery pack. Alternatively, the battery pack 1 may be configured directly from an arrangement of battery cells 10 without any battery modules, as illustrated. Since the battery cells 10 themselves have a large volume, there may be no particular difficulty in implementing the battery pack 1 even without using intermediate structures like battery modules.

Moreover, the battery pack 1 may further include various other components in addition to the battery cell 10, such as components of the battery pack 1 known at the time of filing of this application, such as a BMS, a pack case, a relay, a current sensor, etc.

A plurality of battery cells 10 may be included in the battery pack 1. The battery cells 10 may be arranged in a predetermined number of rows, and may be arranged such that both the electrode terminal having the first polarity and the electrode terminal having the second polarity of each battery cell 10 are located at the upper side. Therefore, when electrically connecting the plurality of battery cells 10, both positive electrodes and negative electrodes may be connected in one direction, thereby simplifying the electrical connection structure. Through this, the number of battery cells 10 that can be mounted in the same space may be increased, thereby improving the energy density, and facilitating electrical wiring work. Therefore, since the space efficiency is good and the electrical wiring efficiency is high, there is a significant work improvement effect in the assembly process of the electric vehicle, and in the assembly and maintenance of the battery pack 1. In addition, each of the battery cells 10 may have a higher energy density than conventional battery cells, as described above. The battery pack 1 with the increased energy density may store the same energy while reducing its volume and load.

Therefore, if the battery pack 1 to which the above battery cells 10 are applied is installed in a vehicle such as a vehicle M that uses electricity as an energy source as shown in FIG. 14, the mileage of the vehicle may be further increased in proportion to the energy consumed.

Referring to FIG. 14, the vehicle M according to the present disclosure may include at least one battery pack 1 according to the present disclosure.

The battery cell 10 according to the present disclosure may be applied to a vehicle such as an electric vehicle or a hybrid vehicle. That is, the vehicle M according to the present disclosure may include the battery cell 10 according to the present disclosure or the battery pack 1 according to the present disclosure. In addition, the vehicle M according to the present disclosure may further include various other components included in the vehicle in addition to the battery cell 10 or the battery pack 1. For example, the vehicle M according to the present disclosure may further include a body, a motor, a control device such as an ECU (electronic control unit), in addition to the battery cell 10 according to the present disclosure. The vehicle M includes a four-wheel vehicle and a two-wheel vehicle. The vehicle M may operate by receiving power from the battery pack 1 according to aspects of the present disclosure.

The present disclosure has been described in detail. However, it should be understood that the detailed description and specific examples, while indicating preferred aspects of the disclosure, are given by way of illustration only, since various changes and modifications within the scope of the disclosure will become apparent to those skilled in the art from this detailed description.

1. A battery cell, comprising:
an electrode assembly including a first electrode, a second electrode, and a separator interposed between the first electrode and the second electrode, the electrode assembly being wound about a winding axis and having a winding center hole at a center of the electrode assembly extending along the winding axis;
a battery housing accommodating the electrode assembly therein and having an open end formed at one side thereof;
a lead covering the open end of the battery housing, the lead having an injection hole extending therethrough at a center thereof, and
a plug located within the injection hole and sealing the injection hole,
wherein the injection hole has a diameter that is smaller than a diameter of the winding center hole.

2. The battery cell according to claim 1, wherein the lead includes an edge portion at a peripheral edge of the lead that is directly welded to the battery housing without beading or crimping of the battery housing.

3. The battery cell according to claim 1, wherein the lead is an integrated lead, such that the lead serves as a current collection plate and a lead, without a separate current collection plate electrically connected between the lead and the electrode assembly.

4. The battery cell according to claim 1, wherein the diameter of the injection hole is 50% to 80% of the diameter of the winding center hole of the electrode assembly.

5. The battery cell according to claim 1, wherein the diameter of the injection hole is 2 mm to 7 mm.

6. The battery cell according to claim 1, wherein the diameter of the winding center hole is 4 mm to 8 mm, and the diameter of the injection hole is 2.5 mm to 6.5 mm.

7. The battery cell according to claim 1, wherein the plug includes an insert portion extending into at least a part of the injection hole, and the plug has a welding portion at least partially welded to the lead.

8. The battery cell according to claim 7, wherein a diameter of the insert portion is smaller than the diameter of the injection hole, and a diameter of the welding portion is larger than the diameter of the injection hole.

9. The battery cell according to claim 7, wherein the welding portion of the plug has a step at a peripheral edge portion thereof having a thickness that is less than a thickness of a remainder of the welding portion, the battery cell further comprising a welding bead located in a space above the step, the welding bead not protruding above an upper surface of the remainder of the welding portion.

10. The battery cell according to claim 1, wherein the lead includes a flat portion surrounding the injection hole, an edge portion at a peripheral edge of the lead and coupled to the battery housing, and at least one electrode coupling portion, each electrode coupling portion coupled to the electrode assembly, each electrode coupling portion located between the flat portion and the edge portion and recessed towards the electrode assembly relative to the flat portion and the edge portion.

11. The battery cell according to claim 10, wherein the at least one electrode coupling portion is a plurality of electrode coupling portions spaced apart from each other in a circumferential direction extending around the winding axis.

12. The battery cell according to claim 11, wherein each electrode coupling portion has a bottom surface directly contacting and coupled to the electrode assembly.

13. The battery cell according to claim 11, wherein the plurality of electrode coupling portions includes three electrode coupling portions.

14. The battery cell according to claim 11, wherein the lead includes at least one bridge extending in a radial direction perpendicular to the winding axis and the circumferential direction from the flat portion towards the edge portion, each bridge extending between two adjacent ones of the electrode coupling portions.

15. The battery cell according to claim 11, wherein the electrode coupling portions are together distributed about the center of the lead in the circumferential direction, the electrode coupling portions being arranged symmetrically relative to the center of the lead.

16. The battery cell according to claim 1, wherein the lead includes a plug coupling portion into which the plug is inserted and seated and coupled, and the injection hole is located at a center of the plug coupling portion.

17. The battery cell according to claim 10, wherein the flat portion includes a bent portion recessed toward the injection hole, and each electrode coupling portion includes an extension portion extending toward the bent portion.

18. The battery cell according to claim 10, wherein the lead includes a notched vent portion extending between each electrode coupling portion and the edge portion.

19. The battery cell according to claim 11, wherein the lead has a picking portion arranged between two adjacent ones of the electrode coupling portions and the edge portion, the picking portion having a picking area configured to be contacted by a picking device.

20. A battery pack comprising the battery cell according to claim 1 and a pack housing accommodating the battery cell therein.

21. A vehicle comprising the battery pack according to claim 20.

22. A method of manufacturing a battery cell, the method comprising:
winding an electrode assembly including a first electrode, a second electrode, and a separator interposed between the first electrode and the second electrode, the electrode assembly being wound about a winding axis and having a winding center hole at a center of the electrode assembly extending along the winding axis;
inserting the electrode assembly into a battery housing accommodating through an open end formed at one side thereof;
welding a lead to the open end of the battery housing, the lead having an injection hole extending therethrough at a center thereof;
injecting an electrolyte into the battery housing through the injection hole; and
inserting a plug into the injection hole to seal the injection hole,
wherein the injection hole has a diameter that is smaller than a diameter of the winding center hole.

23. The method according to claim 22, wherein the lead has an edge portion at a peripheral edge of the lead that is directly welded to the battery housing without beading or crimping of the battery housing.

24. The method according to claim 22, wherein the lead is an integrated lead, such that the lead serves as a current collection plate and a lead, without a separate current collection plate electrically connected between the lead and the electrode assembly.

25. The method according to claim 22, further comprising, before the injecting of the electrolyte into the battery housing, inserting a welding rod through the injection hole and welding a lower current collection plate to a terminal at a closed end of the battery housing opposite from the open end.

26. The method according to claim 22, further comprising, after the welding of the of the lead to the open end of the battery housing, welding at least one electrode coupling portion of the lead to the electrode assembly.
